(19) United States
(12) Patent Application Publication
(10) Pub. No.: US 2018/0328567 A1
(43) Pub. Date: Nov. 15, 2018

(54) Head for a children's clip light

(71) Applicant: Nicole Trevino, Raymondville, TX (US)

(72) Inventor: Nicole Trevino, Raymondville, TX (US)

(21) Appl. No.: 15/978,123

(22) Filed: May 12, 2018

Related U.S. Application Data
(60) Provisional application No. 62/602,933, filed on May 12, 2017.

(51) Int. Cl. F21V 3/02; F21V 21/088; F21L 4/04; F21V 17/00; F21V 17/12

(52) U.S. Cl. CPC F21V 3/02; F21V 21/0885; F21V 17/12; F21V 17/002; F21L 4/04

(57) ABSTRACT

A head, for a clip light, that includes a transparent twist on top that can be an animal, cartoon character, or inanimate object followed by a white plastic in the shape of a light bulb, which has an internal housing with an LED light attached and then is twisted onto the bottom of the head.

### CROSS-REFERENCE TO RELATED APPLICATIONS

This application claims the benefit of and priority to U.S. Provisional Patent Application No. 62/602,933.

### STATEMENT REGARDING FEDERALLY SPONSORED RESEARCH OR DEVELOPMENT

Not applicable.

### REFERENCE TO A SEQUENCE LISTING, A TABLE, OR A COMPUTER PROGRAM LISTING COMPACT DISC APPENDIX

Not applicable.

### BACKGROUND OF THE INVENTION

The present invention relates to the head of a clip light.

### BRIEF SUMMARY OF THE INVENTION

The primary objective of the present invention is to provide entertainment or comfort for children and infants by using various animals, cartoon characters, or inanimate objects for the top of the head that is for a clip light.

Another objective of the present invention is to aid parents while driving by helping to soothe crying infants or children.

### BRIEF DESCRIPTION OF THE SEVERAL VIEWS OF THE DRAWINGS

FIG. 1 is a perspective view showing a way my invention can be used with a flexible goose neck and clip that is meant for a rechargeable clip light.

FIG. 2 is a front view of the top to my invention in the shape of a baseball.

FIG. 3 is a front view of the top to my invention in the shape of a monkey.

FIG. 4 is a left side view showing a way my invention without the top can be used with a flexible goose neck and clip that is meant for a rechargeable clip light.

FIG. 5 is a right side view showing a way my invention without the top can be used with a flexible goose neck and clip that is meant for a rechargeable clip light.

FIG. 6 is an exploded perspective view showing a way my invention can be used with a flexible goose neck and clip that is meant for a rechargeable clip light.

### DETAILED DESCRIPTION OF THE INVENTION

FIG. 1 illustrates a perspective view example of a way my invention 20 can be used with a flexible goose neck and clip that is meant for a rechargeable clip light 22. The top is in the shape of a monkey 10 and is also transparent, revealing the white plastic shaped like a light bulb 14 underneath it. The top can be various other animals, cartoons characters, or inanimate objects and is twisted onto the bottom of the head 18.

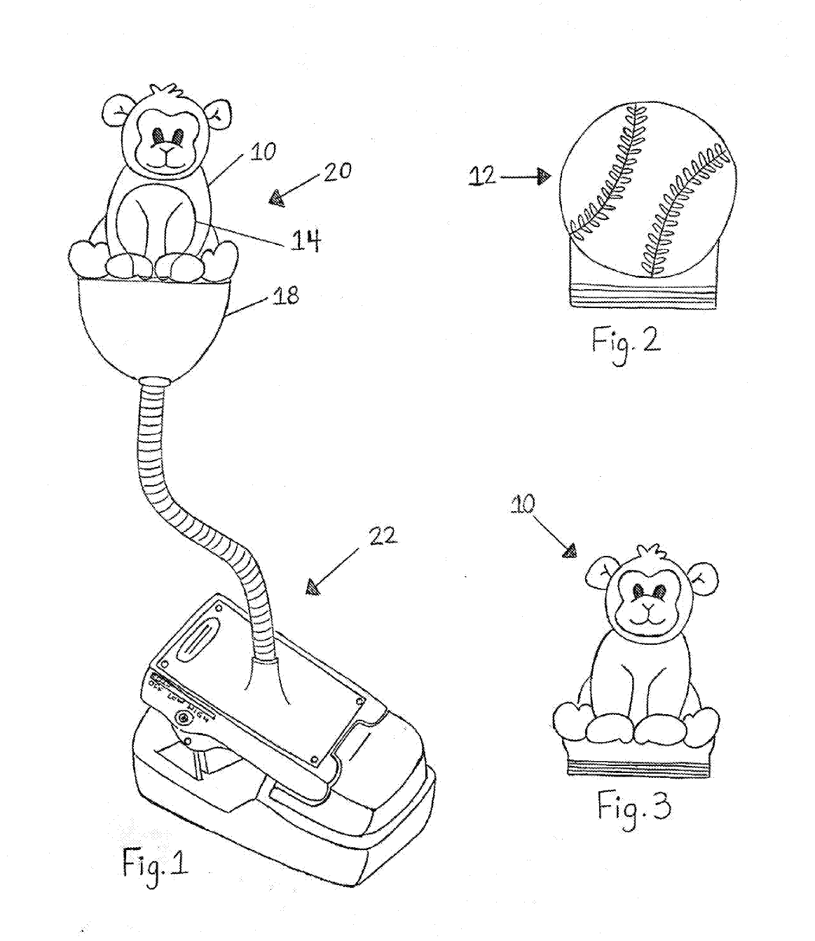

FIG. 2 illustrates a front view of the top to my invention as a baseball 12. Therefore, it shows my invention as an inanimate object.

FIG. 3 illustrates a front view of the top to my invention in the shape of a monkey 10, which is separated from the bottom part of my invention.

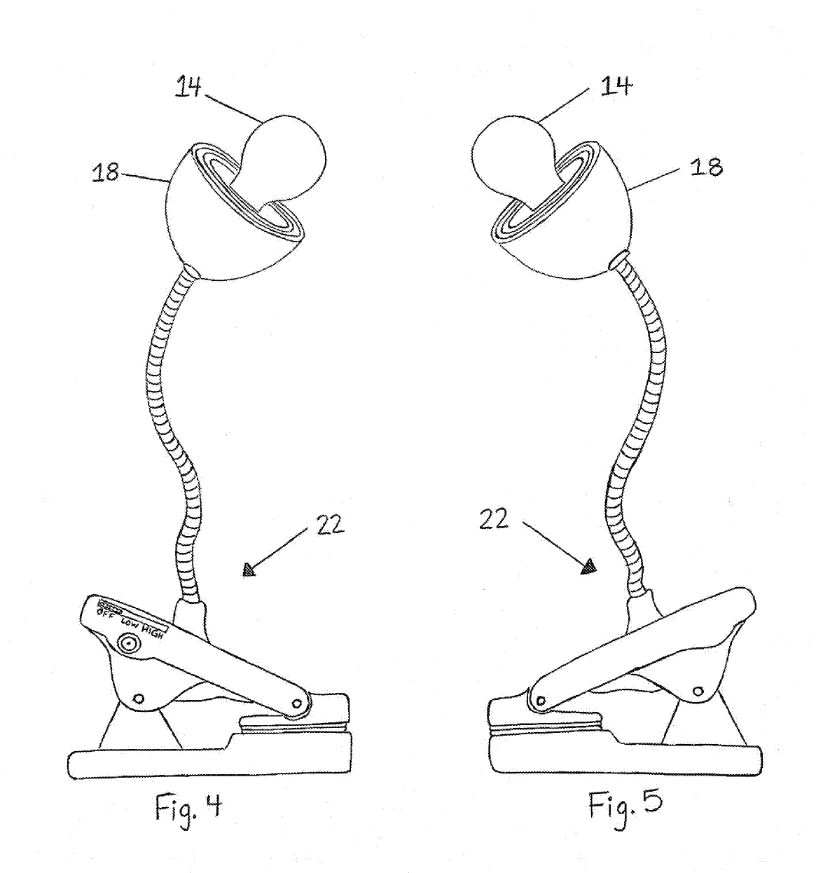

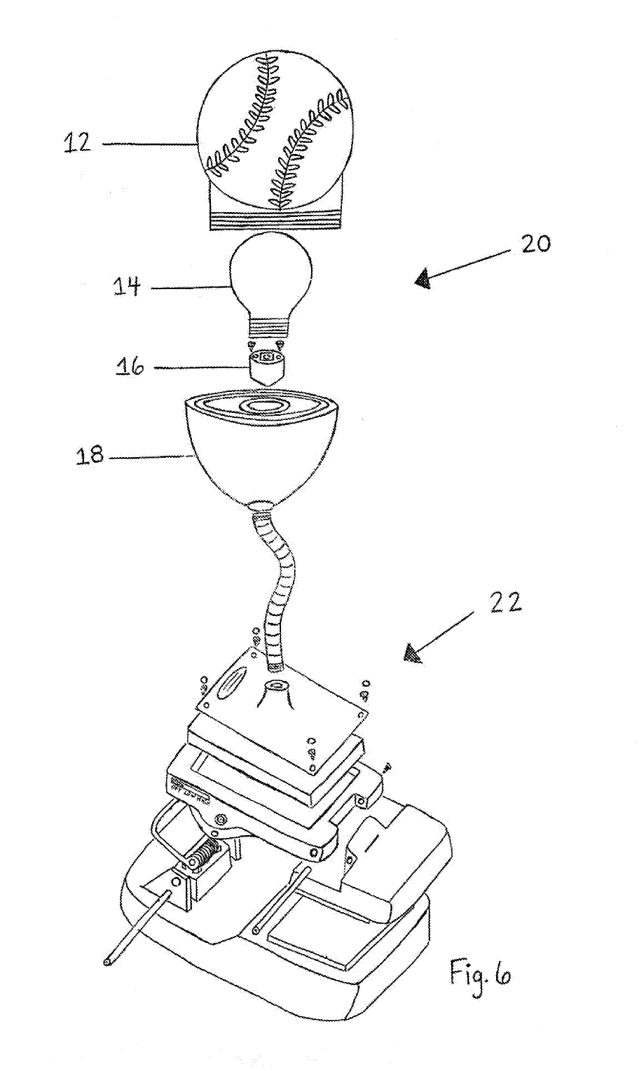

FIG. 4 and FIG. 5 illustrate examples of the left and right side views of my invention without the top along with a flexible goose neck and clip that is meant for a rechargeable clip light 22. A white plastic shaped like a light bulb 14 is twisted onto the bottom of the head 18.

FIG. 6 illustrates an exploded perspective view of a way my invention can be used with a flexible goose neck and clip that is meant for a rechargeable clip light 22. First, there is the top which is in the shape of a baseball 12 followed by a white plastic in the shape of a light bulb 14. Then, there is the internal housing 16, which has an LED light attached to it. Last there is the bottom of the head 18, which is where the baseball 12 and the white plastic shaped like a bulb 14 are twisted onto.

1. The invention claimed is a head, for a clip light, that includes a transparent twist on top that can be an animal cartoon character, or inanimate object followed by a white plastic in the shape of a light bulb, which has an internal housing with an LED light attached and then is twisted onto the bottom of the head.
